(19) United States
(12) Patent Application Publication
(10) Pub. No.: US 2024/0117937 A1
(43) Pub. Date: Apr. 11, 2024

(54) TANKS FOR STORING VOLATILE GAS UNDER PRESSURE AND STRUCTURES COMPRISING SUCH TANKS

(71) Applicant: VIRITECH LTD, London (GB)

(72) Inventors: Matthew Robert FAULKS, Clifton Reynes (GB); Romilly Francesca CLOSE, Leicestershire Loughborough (GB); Nicholas Leo WEATHERBY, Nottingham (GB); Laurence TURNER, Chilton (GB)

(73) Assignee: VIRITECH LTD, London (GB)

(21) Appl. No.: 18/546,096

(22) PCT Filed: Feb. 11, 2022
(86) PCT No.: PCT/GB2022/050385

§ 371 Date: Aug. 10, 2023

(30) Foreign Application Priority Data
Feb. 11, 2021 (GB) 2101944.3

(51) Int. Cl. F17C 1/16; F17C 1/08; F17C 13/08

(52) U.S. Cl. CPC F17C 1/16; F17C 1/08; F17C 13/08; F17C 2201/0109; F17C 2203/012; F17C 2203/0614; F17C 2203/0673; F17C 2203/0697; F17C 2205/0107; F17C 2205/0388; F17C 2223/0146; F17C 2223/036

(57) ABSTRACT

The disclosure relates to a tank for storing volatile gas under pressure and a structure comprising the tank. The tank has a wall formed of a filament wound carbon fibre reinforced polymer (CFRP). The CFRP may have a graphene nanomaterial filler dispersed in the polymer adhesive matrix. The structure includes a frame for bearing static and dynamic forces from internal and external loads, the frame including the tank, the tank being an active load bearing structural element configured as a stressed member in the frame such that, in the structure in use, the tank bears static and dynamic forces from internal and external loads. One or more of: the filament winding pattern of the carbon fibre, the wall thickness, the wall shape, or the material properties of the polymer matrix including the dispersed graphene; is configured such that the tank has mechanical properties required by the design of the structure.

### TECHNICAL FIELD

The present disclosure relates to tanks for storing gases under pressure. In particular examples, the disclosure relates to tanks for use in vehicles to store hydrogen as a fuel gas for driving a powertrain of the vehicle.

### BACKGROUND

The ubiquitous use of fossil fuels as a source of energy for driving internal combustion engines in powertrains to propel vehicles, or for local power generation, is a significant source of greenhouse gas emissions and also localised pollution. Endeavours to transition away to a low-carbon economy and to reduce emissions from burning fossil fuels, for example in vehicle transportation in urban centres, have led to alternative stores of energy being investigated that are clean at the point of use in that they do not generate emissions or pollutants when used.

The use of electrochemical secondary cells to store energy for later emission-free conversion as a source of electrical power, for example to drive electrical motors to propel vehicles, has been increasingly used as an alternative. However, such battery storage is not without drawbacks in that, in automotive applications for example, the range currently achievable using battery electric vehicles is typically limited to a 100-200 miles using a full charge, and the time required to replenish the charge stored in the secondary cells can lead to range anxiety and present difficulties for long-distance travel. Further still, the supply of lithium that is needed for secondary cells may not be able to keep pace with increased demand for battery storage over the coming years. Thus the lack of suitability of battery storage for all applications, and the anticipated constraints on supply mean that viable alternative stores of energy are needed if we are to successfully transition away from fossil fuels.

An alternative energy store is hydrogen, which can be converted to electrical energy on demand by passing it over an electrolytic membrane in a stacked fuel cell, which can then be used as a source of power, for example to power electrical motors to propel vehicles. The conversion of stored hydrogen to electrical energy in a fuel cell produces only heat and water as byproducts, and as a result is completely carbon-free and does not produce other pollutants at the point of use. Further, processes to produce hydrogen using green energy from renewable sources are being commercialised that provide a means for hydrogen to become a zero carbon source of power for transportation and local electricity generation. Further still, hydrogen fuel cells are not dependent on the availability of lithium in order the meet market demand for green energy sources. Fuel cells can continue in their operation for as long as there is a supply of hydrogen from a source, which is typically stored under pressure as a liquid or gas in a hydrogen storage tank. These storage tanks can be replenished quickly at refuelling stations, and, like internal combustion engines, can provide continuous power for example for long range travel with short downtimes for refuelling, in vehicular applications.

It is in this context that the presently disclosed subject matter is devised.

### SUMMARY OF THE DISCLOSURE

To accommodate the high pressures needed to store hydrogen robustly, storage tanks are currently very bulky and heavy compared to the weight of fuel stored. This means that hydrogen storage adds significant space and bulk requirements, and significant weight, to hydrogen powered vehicles or generators, adding to the design constraints and reducing the efficiency of hydrogen-powered transport. For example, in current hydrogen powered cars, hydrogen storage tanks are positioned behind the rear seats where they are more protected, which occupies significant space within the vehicle, and adds significant weight.

Aspects of the disclosure provide a tank for storing volatile gas under pressure and a structure comprising the tank. The tank has a wall formed of a filament wound carbon fibre reinforced polymer. In embodiments, the wall may be formed of a filament wound carbon fibre reinforced polymer having a graphene nanomaterial filler dispersed in the polymer adhesive matrix. The structure comprises a frame for bearing static and dynamic forces from internal and external loads, the frame comprising the tank, the tank being an active load bearing structural element configured as a stressed member in the frame. In embodiments, the tank is configured such that, in the structure in use, the tank bears static and dynamic forces from internal and external loads. In embodiments, the tank is formed by design to have mechanical properties required of the structural element in the frame such that the structure complies to its required specification to fulfil its mechanical function. In embodiments, one or more of: the filament winding pattern of the carbon fibre, the wall thickness, the wall shape, or the material properties of the polymer matrix including the dispersed graphene; is configured such that the tank has mechanical properties required by the design of the structure.

In embodiments, the tank may be formed to provide one or more integrated hardpoints for mechanical connection to other structural elements of the frame or for supporting other non-load bearing components of the structure. In embodiments, the hardpoints may comprise fixing parts integrated into the filament winding and overmoulded by or embedded in the polymer adhesive. In embodiments, the fixing parts may comprise one or more plates embedded in filament wound layers of the wall, and one or more anchors extending through the plate or plates and out of the wall to provide fixings for mechanical connection to other structural elements of the frame or for supporting other non-load bearing components of the structure.

In embodiments, the tank may further comprise a structural mesh sleeve surrounding the tank, the structural mesh sleeve extending from the tank wall and being for coupling the tank to the structure in use such that the tank provides an active load bearing structural element in the frame of the structure. In embodiments, the structural mesh sleeve may be embedded in the tank wall in at least a polymer adhesive matrix of the tank wall. In embodiments, the structural mesh sleeve may be integrated in the filament winding of the tank wall. In embodiments, the structural mesh sleeve may have one or more fixing means for mechanical connection to other structural elements of the frame or for supporting other non-load bearing components of the structure.

In embodiments, the tank may further comprise a structural rod extending in the tank along its longitudinal axis and through the tank wall at opposite ends of the tank, the structural rod being for coupling the tank to the structure in use such that the tank provides an active load bearing structural element in the frame of the structure. In embodiments, the filament winding of the tank wall may be formed around the structural rod, such that the structural rod is embedded in the tank wall. In embodiments, collars may be arranged on the rod each having a flange extending radially from the rod, and the filament winding of the tank wall may be wound around a collar at opposite ends of the rod. In embodiments, the rod may have a hollow cross section defining a cavity, the rod being configured for fluid communication of pressurised gas to and from the tank. The tank may further comprise a pressure regulator provided in sealed fluid communication with the cavity of the rod in order to convert the pressurised gas between the tank pressure and an external system pressure.

In embodiments, the structure is a vehicle, and the frame is a chassis of the vehicle, and wherein the tank is for storing pressurised fuel for delivery to a powertrain of vehicle in use.

In accordance with the aspects of the disclosure, a lightweight tank for storing volatile gas is provided that can be made to be sufficiently strong such that, rather than being a passive load to be accommodated in and supported by a structure in use, the tank itself can be provided as an active load bearing structural element as a stressed member in a frame of a structure such that, in the structure in use, it bears static and dynamic forces from internal and external loads. In this way, instead of providing significant additional weight to be borne by the frame of a structure, the storage tank can itself form part of the frame of the structure, thereby providing the requisite strength, rigidity and other mechanical properties needed as a structural element in the frame. The storage tank thus supplants the structural element of the frame that would otherwise need to be provided, and the need to provide an additional large and heavy hydrogen storage tank that would have to be accommodated in and supported by the frame is avoided. In embodiments, for example, the frame may be a chassis of a hydrogen powered vehicle, and the tank may form a stressed member of the chassis.

### BRIEF DESCRIPTION OF THE DRAWINGS

Certain example embodiments of aspects of the present invention will now be described with reference to the accompanying drawings in which:

FIG. 1 is an example structure of comprising a frame including a tank for storing volatile gas under pressure as an active load bearing structural element thereof;

FIG. 2a is an example illustration of a cross section of the tank for storing volatile gas under pressure shown in FIG. 1, illustrating an example formation process thereof;

FIG. 2b is a detail of the wall of the tank shown in FIG. 2a;

FIG. 3 shows another embodiment of a tank for storing volatile gas under pressure in accordance with aspects of the present disclosure;

FIG. 4 shows a cross section of the wall of part of the tank shown in FIG. 3 following the formation of the wall by filament winding;

FIG. 5 shows another embodiment of a tank for storing volatile gas under pressure in accordance with aspects of the present disclosure, in which a structural mesh sleeve is provided around the tank wall; and

FIG. 6 shows a cutaway view of another embodiment of a tank for storing volatile gas under pressure in accordance with aspects of the present disclosure, sectioned down its longitudinal axis in which a structural rod extends through the tank.

### DETAILED DESCRIPTION

Aspects of the disclosure provide a tank for storing volatile gas under pressure and a structure comprising the tank.

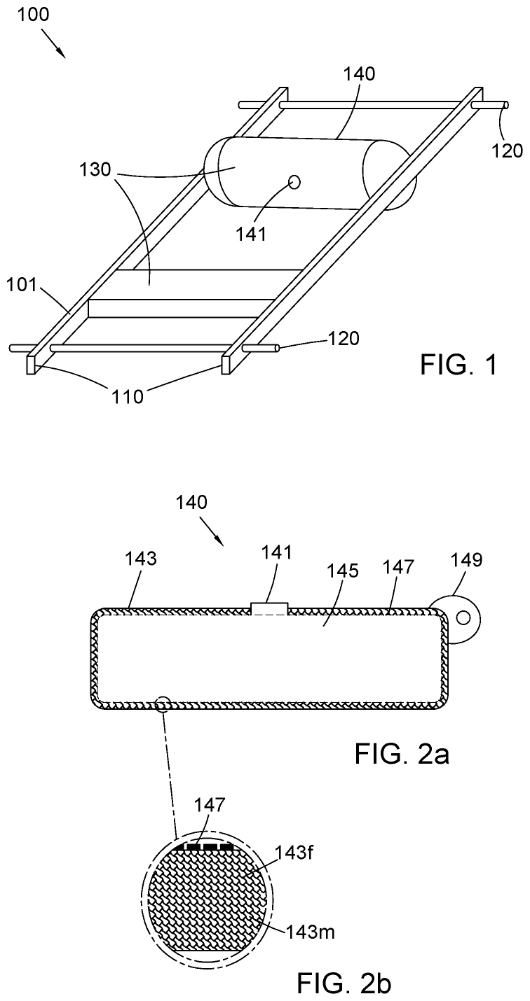

FIG. 1 shows an example structure 100 in accordance with aspects of the invention which comprises a frame 101 arranged as a system of connected structural elements configured to resist internal and external loads applied to the structure 100 in use, so as to maintain the structural integrity thereof and to allow the structure 100 to continue to perform its overall function. In the example, the structure 100 is a vehicle in the form of a hydrogen-powered car, and the frame 101 is a chassis thereof. However, the disclosure is not limited thereto and the structure may be any suitable physical system or object in which a tank storing volatile gas under pressure may need to be stored and used, including vans, trucks, trailers motorcycles, and other land transport vehicles, as well as trains, heavy lifting and construction equipment, yachts, ships, submarines and other waterborne vessels and fixed and mobile sea-based platforms, aeroplanes, helicopters, drones and other airborne vehicles, rockets, or elements of a reusable launch system for launching payloads into orbit. As well as vehicles for transportation, the structure may be a static structure such as a building or a container for a generator of mechanical or electric power.

In FIG. 1, the example illustrated is an overly simplified chassis 101 (or part thereof as a number of structural elements are omitted. The chassis 101 comprises a tank 140 for storing volatile hydrogen gas under pressure for providing an energy source for a powertrain (not shown) of the vehicle 100, which may include a fuel cell for generating electricity by consuming the hydrogen, connected to one or more motors which are controlled to drive the wheels of the vehicle. The chassis 101 may be of any suitable design for providing structural integrity to the vehicle 100 in use, and it may be a unibody construction, a ladder construction, a body-on-frame construction, or any other suitable construction.

In the example, the chassis 101 comprises fore-and-aft rail members 110 formed of tubular steel. The rail members 110 are supported by through axles 120, which are themselves suspended between wheels (not shown), thereby supporting the chassis 101 above a driving surface. The rail members 110 are held spaced apart by cross members 130 which are mechanically interconnected with the rail members 110 and other members of the chassis 101 such that the chassis bears static and dynamic forces from internal and external loads in use. For example, the external loads are exerted on the structure 100 as the vehicle drives over the driving surface, whereas internal loads come from the supporting by the chassis 101 of inactive structural members and loads in the vehicle 100. For example, chassis 101 supports and bears an internal load of the powertrain of the vehicle in use. The rear crossmember 130 is provided by a tank 140 for storing hydrogen fuel gas under pressure. In the example the tank 140 is shown as being generally cylindrical in shape with rounded ends, although this is not limiting and the tank 140 is formed to assume the designed shape of the structural member of the chassis 101 it is to provide.

The chassis 101 may be of a unibody construction and the tank 140 may be secured across the underside of the unibody chassis as a cross member thereof. However, the disclosure is not limited to this arrangement and in other example embodiments, one or more structural members of a chassis of a vehicle may be provided by such a tank. In other examples, the chassis may be of a unibody construction, and the tank forms a stressed member thereof. In other examples, the chassis comprises a subframe (for example a frame for supporting the fuel cell, suspension or other components, that is mounted to and is then part of a unibody or other chassis construction) or a body-on-frame construction, and the tank forms a stressed member thereof.

The tank 140 is formed to provide an active load bearing structural element as a stressed member in a chassis 101 of the vehicle 100 such that, in the vehicle 100 in use, the tank 140 bears static and dynamic forces from internal and external loads.

As can be seen from FIG. 2a, and in detail in FIG. 2b, the tank 140 comprises an opening 141 in a wall 143 forming a hollow chamber 145 of the tank 140, the opening 141 being sealed in use for retaining in the chamber 145 a volatile gas such as hydrogen under pressure in liquid or gas form. The pressure in the chamber 145 when full may be in the range of 250 to 1000 bar. In examples the pressure may be 300-500 bar, or in other examples the pressure may be 800-900 bar.

The tank 140 is extremely lightweight, stiff and strong enough to be able to contain the gas under pressure and to be able to form an integral structural element of the frame/chassis 101 by virtue of the material construction of the wall 143. In particular, the wall 143 is formed of a filament wound carbon fibre reinforced polymer (CFRP) having, in embodiments, a graphene nanomaterial filler dispersed in the polymer adhesive matrix. The wall 143 may also be formed of a filament wound graphene fibre reinforced polymer or a mixture of carbon fibre and graphene fibre together.

The tank 140 may be formed by a filament winding process winding the carbon fibre filament around a mandrel 147 to form a filament winding 143f of the desired shape for the tank 140 to provide the structural member of the frame (in the example, the cross member 130 of the chassis 101).

During the filament winding process, the carbon fibre filament may be drawn through a bath containing the polymer adhesive before winding around the mandrel 147, such that, after the filament winding 143f has been formed, the polymer adhesive forms a matrix material of the CFRP composite. The bath of polymer adhesive may have a graphene nanomaterial filler dispersed therein, such that the a graphene nanomaterial filler is dispersed in the resulting matrix material. Alternatively, or in addition, after the filament winding 143f has been formed, the filament winding structure may be impregnated with a resin for example of a thermoset plastic or epoxy, for example, by immersing it in a bath. Again this bath may have a graphene nanomaterial filler dispersed therein. This is then cured and hardened to form a composite matrix material 143m in which the graphene nanomaterial filler dispersed and the filament winding 143f may be embedded, thereby sealing, strengthening and retaining the filament winding to form a wall 143 of the tank. In embodiments, the graphene nanomaterial filler dispersed in the polymer adhesive matrix may comprise graphene nanoplatelets. Graphene nanofiller dispersed in a filament wound carbon fibre matrix provides a lightweight, high durability, high strength tank wall 143 that can be formed to shapes and mechanical properties required by design to be sufficient to provide active load bearing structural elements of frames (for example, of a vehicle chassis) while robustly retaining a volatile gas under pressure.

Generally, the use of a filament wound carbon fibre reinforced polymer having a graphene nanomaterial filler dispersed in the polymer adhesive matrix as a wall 143 of the tank 140 allows the tank 140 to be formed as a lightweight vessel for storing volatile gases such as hydrogen at high pressure, while also allowing the tank to be formed to provide an active load bearing structural element as a stressed member in a frame of a structure such that, in the structure in use, it bears static and dynamic forces from internal and external loads. By forming a lightweight tank in this way, it can be made to be sufficiently strong such that, rather than being a passive load to be accommodated in and supported by a structure in use, the tank itself can be provided as an active load bearing structural element as a stressed member in a frame of a structure such that, in the structure in use, it bears static and dynamic forces from internal and external loads.

In this way, instead of providing significant additional weight to be borne by the frame of a structure, the lightweight storage tank can itself form part of the frame of the structure, thereby providing the requisite strength, rigidity and other mechanical properties needed as a structural element in the frame. The storage tank thus supplants the structural element of the frame that would otherwise need to be provided and the need to provide an additional large and heavy hydrogen storage tank that would have to be accommodated in and supported by the frame is avoided. Further still, the structure accommodates a high amount of gas under pressure compared to its weight. In embodiments, the tank is formed such that the weight of the tank when full at operating pressure is at least 107% of the weight of the tank when empty. In other embodiments, the tank is formed such that the weight of the tank when full at operating pressure is at least 110% of the weight of the tank when empty. In yet other embodiments, the tank is formed such that the weight of the tank when full at operating pressure is at least 113% of the weight of the tank when empty. Higher fuel-to-tank weight ratios are achievable with this design.

Indeed, in embodiments, the tank 140 may be formed by design to have mechanical properties required of the structural element in the frame such that the structure complies to its required specification to fulfil its mechanical function. For example, one or more of: the filament winding pattern of the carbon fibre, the wall thickness, the wall shape, or the material properties of the polymer matrix including the dispersed graphene; may be configured such that the tank has mechanical properties required by the design of the structure. For example, the winding pattern may be designed to give the tank 140 the required mechanical properties (for example, of strength and rigidity in certain directions) required of the structural element it is to provide in the frame. For example, a combination of high angle hoop structures and low angle polar or helical patterns may be used to give the tank a required circumferential strength or longitudinal tensile strength.

A hardpoint structure 149, such as a separate fixing part formed of steel, titanium, aluminium or CFRP, is integrated into the tank for mechanical connection to other structural elements of the frame or for supporting other non-load bearing components of the structure. The hardpoint structure 149 may comprise a fixing part integrated into the filament winding and overmoulded by or embedded in the polymer adhesive.

After the tank 140 has been formed, the mandrel 147 may be removed through the opening 141 which may thereafter be sealed to allow the gas to be filled and retained in the chamber 145 under pressure. In other embodiments, the mandrel 147 may remain inside the tank 140 and be arranged to provide a liner for containing the gas inside the chamber 145, the liner 147 being retained by the wall 143 which gives the requisite strength to the tank 140. In embodiments, the mandrel 147 however is removed and the tank 140 is provided for use as a linerless type V hydrogen tank. This conserves further weight and provides a yet lighter tank construction. If a liner is provided, it may be formed of high density polyethylene or nylon.

Once the tank 140 is formed to the suitable design to provide the structural element, it is assembled with and fitted to the remainder of the chassis 101 in its intended location. In the example the tank 140 is provided as a cross member 130 between the fore and aft rails 110. The tank 140 may take a different form and be fitted to the other parts of the chassis or frame 101 to provide a structural element thereof by any suitable fixing method including bonding, diffusion bonding, by mechanical fixings, or any suitable combination of fixing methods. Hardpoints 149 may be used for such fixing points.

In situ in the frame 101, the tank 140 provides a stressed member thereof such that, in the structure 100 in use, the tank 140 bears static and dynamic forces from internal and external loads, including, but not limited to shear, bending and torsional stresses. The tank 140 has mechanical properties sufficient to act as the structural element in the frame 101 such that the structure 100 as a whole complies to its required specification to fulfil its mechanical function. For example, the chassis 101 including the tank 140 may as a whole ensure that the vehicle 100 is able to withstand internal and external forces (some of which are born through the chassis 101 by tank 140) experienced by the vehicle 100 within its normal range of operation, thereby ensuring the vehicle 100 retains its structural integrity in normal use throughout its serviceable life. Further still, the tank 140 is designed such that its use as an active structural element in the frame 101 has no negative impact on its performance as a tank for storing volatile gas at pressure, including safety, strength, and ability to retain gasses. The tank 140 may be directly mechanically connected to the frame 101 of the structure to provide an integral structural element of the frame 101, and the tank may be specifically designed and configured to have the mechanical properties sufficient to act as the structural element in the frame 101. That is, the tank 140 may not be a generically formed tank that is indirectly coupled into the frame by being held or supported by separate specifically formed structural elements providing designed to distribute some load to the tank, the tank and the coupling structural elements together forming an assembly having mechanical properties sufficient to act as a structural element in the frame.

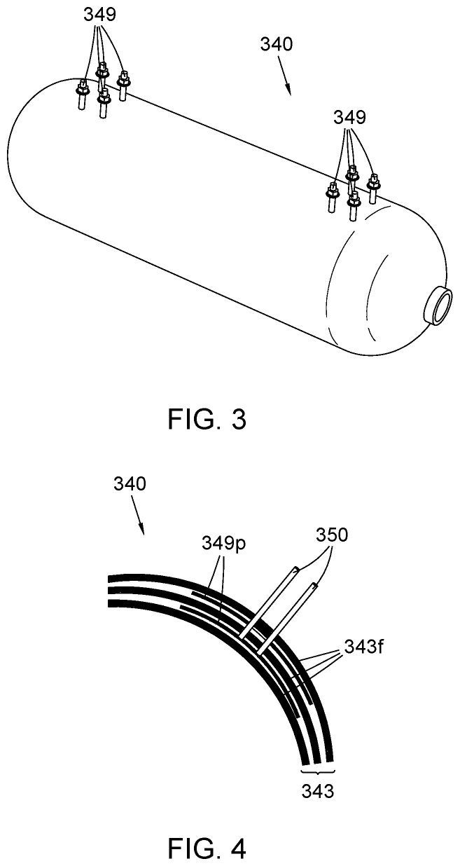

FIG. 3 shows another embodiment of a tank 340 for storing volatile gas under pressure in accordance with aspects of the present disclosure, in which a plurality of fixings 349 are provided as hardpoint structures embedded in the tank wall. The fixings 349 provide for mechanical connection to other structural elements of the frame or for supporting other non-load bearing components of the structure. For example, the fixings 349 may be for directly mechanically coupling the tank 340 into the chassis of a vehicle such that the tank 340 provides a load bearing structural element thereof.

Regarding the formation of the fixings 349, FIG. 4 shows a cross section of the wall 343 of part of the tank 340 shown in FIG. 3 following the formation of the wall 343 by filament winding. As can be seen, the fixings 349 comprise one or more plates 349p embedded in filament wound layers of the wall 343f. It should be noted here that the embedding of the plates 349p in the layers of the wall 343f shown in FIG. 4 is intended to be illustrative, and away from the plates 349p the successive filament windings around the wall are built up and bonded together by the polymer matrix such that the layers are not separatable in a cross section of the wall. However, as can be seen the fixings 349 are formed by forming an initial layer 343f of the CRFP wall by filament winding around a mandrel, and then placing the securing plates 349p in place on the outside of the layer 343f before curing. The securing plates may already have the fixing anchors extending from them away from the wall, or removable pins 350 may be provided seated in threads in the plates 343p. The anchors or removable pins 350 may allow the vessel wall to continue to be formed by winding further layers 343f of CFRP over the initial plate 349p such that the securing plate 349p becomes embedded in the tank wall 343. As wall is filament wound with further layers 343f added, additional securing plates 349p may be added over the pins, threaded in place, with one or more such plates 349p being provided embedded in the wall 343 by the time the filament winding is finished and the polymer matrix cured. By including embedded securing plates 393p in this way, the fixing 249 becomes very robust. Once the tank wall 343 has been fully wound and cured, the removable pins 350 can be unscrewed and replaced by fixing anchors or other suitable fixings that are used to mechanically couple the tank 340 to other structural elements of the frame or for supporting other non-load bearing components of the structure. The arrangement and form of the fixings 349 shown in FIGS. 3 and 4 is not intended to be limiting, and suitable fixings can be embedded in the wall 343 of the tank in any appropriate arrangement.

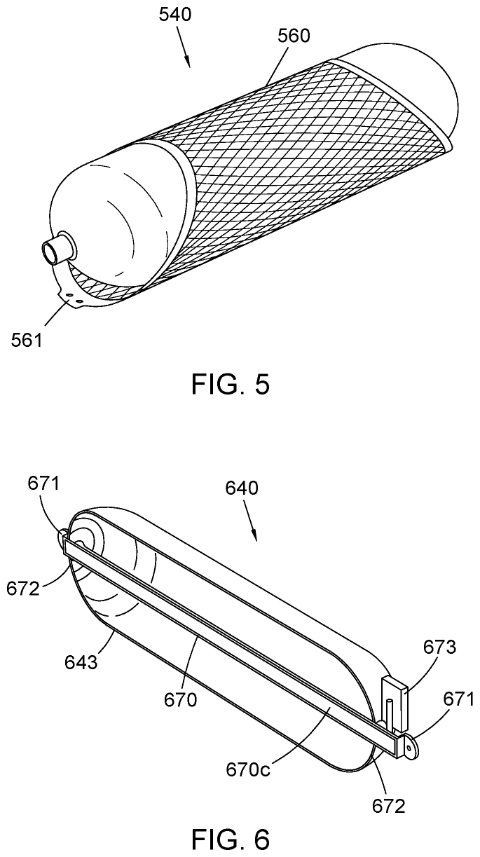

Referring now to FIG. 5, this shows another embodiment of a tank 540 for storing volatile gas under pressure in accordance with aspects of the present disclosure, in which a structural mesh sleeve 560 is provided around the tank wall. The structural mesh sleeve 560 is a separately formed component that the tank 540 is inserted into, the structural mesh providing structural support to the tank and facilitating the tank in providing the structural element of the frame into which it is to be integrated. The mesh can be made of a suitable material which could include stainless steel, aluminium, titanium, or a composite made from a resin and a suitable reinforcement such as carbon fibre or glass. As shown in FIG. 5, the structural mesh sleeve 560 may extend from the tank wall and comprise fixings 561 at locations on the structural mesh sleeve 560 for coupling the tank 540 to other structural elements of the frame or for supporting other non-load bearing components of the structure in use. For example, the fixings 561 may be to mechanically couple the tank 540 to the chassis of a vehicle such that the tank 540 provides an active load bearing structural element in the frame of the chassis in use. Again, the arrangement of the structural mesh sleeve 560 and fixings 561 may be of any suitable arrangement such that the tank 540 provides a structural, load bearing element of the frame. Indeed, structural mesh sleeve 560 allows for the arrangement of integrated fixings in a range of different locations around the tank 540, which allows significant design flexibility in terms of the mass, strength, and space envelope provided by the tank 540 including the structural mesh sleeve. By having a mesh form, the structural mesh sleeve 560 adds significant reinforcement and support to the tank 540, transferring loads to, from and through the tank wall, while also providing a degree of flexibility, such that the mesh allows the tank to expand and contract as it is filled and depleted of pressurised gas. The configuration of the mesh form can be specified such that the tank as a whole is rated to withstand the required applied loads be they tensile, compression, bending or torsion. In order to achieve the mesh can be adapted in terms of mesh geometry, mesh diameter, thickness, material type, and the location and arrangement of fixing anchor points.

Although for the sake of ease of representation and understanding, the structural mesh sleeve 560 is shown in FIG. 5 as sitting outside the tank 540, surrounding and supporting the tank wall, in other embodiments, to further improve the mechanical integration between the structural mesh sleeve 560 and the tank 540, the structural mesh sleeve 560 may be embedded in the tank wall in at least a polymer adhesive matrix of the tank wall, by immersing the tank 540 and the structural mesh sleeve 560 in a polymer adhesive layer before curing, and in other embodiments also by the structural mesh sleeve 560 being integrated in the filament winding of the tank wall by being placed around the tank 540 during the filament winding process and then being overwound, as described above in relation to the hardpoint fixings in FIGS. 3 and 4. When embedded in this way, the mesh construction of the structural mesh sleeve 560 affords a large number of bond points giving a high structural integration between the tank 540 and structural mesh sleeve 560.

FIG. 6 shows a cutaway view of a second embodiment of a tank 640, sectioned down its longitudinal axis. The tank 640 includes a structural rod 670 extending in the tank along its longitudinal axis and through the tank wall 643 at opposite ends of the tank 640. The structural rod 670 has fixings 671 for coupling the tank to the structure in use such that the tank provides an active load bearing structural element in the frame of the structure. The structural rod 670 increases the structural integrity of the tank 640 and the resistance of the tank 640 to loads applied axially to the tank in compression or tension. Due to integration with the tank 640, the structural rod 670 is significantly smaller and less bulky than a rod that would be needed to provide equivalent mechanical properties as the tank. As a result the weight and space efficiency of the tank is high in the context of the structure. The structural rod 670 can be made of any suitable material which could include stainless steel, aluminium, titanium, or a composite made from a resin and a suitable reinforcement such as Carbon fibre or Glass. The structural rod 670 can be designed to be rated to provide the required mechanical properties to withstand the loads that will be applied to the structural rod 670 in the tank 640 in use, be they tensile, compression, bending or torsion. In order to achieve the desired mechanical properties, the design of the structural rod 670 can adapted in its diameter, wall thickness, material and the location and arrangement of fixing anchor points.

As can be seen from FIG. 6, the filament winding of the tank wall 643 is formed around the structural rod 670, such that the structural rod 670 is embedded in the tank wall 643 and is sealed at its join with the tank wall 643 against the internal pressures applied by the pressurised gases in use. To aid integration between the structural rod 670 and the wall collars 672 are arranged on the structural rod 670 each having a flange extending radially from the structural rod 670. The filament winding of the tank wall 643 is wound around a collars 672 at opposite ends of the structural rod 670 such that the structural rod 670 is held in compression by the tank wall 643. This further aids the structural integrity of the tank 640.

As can be seen from FIG. 6, to allow the pressurised gas to be communicated to and from the tank 640 and, for example, the vehicle systems, the structural rod 670 may have a hollow cross section defining a cavity 670c, the structural rod 670 being configured for fluid communication of pressurised gas to and from the tank through the cavity 670c of the rod as it penetrates the longitudinal end of the tank wall 643. Holes in the structural rod 670 may be provided inside and outside the tank 640 to allow this fluid communication. A pressure regulator 673 may be provided in sealed fluid communication with the cavity 670c of the rod in order to convert the pressurised gas between the tank pressure and an external system pressure, such as the pressure at which a Fuel Cell Electric Vehicle's refuelling or fuel cell systems operate.

As well as storing hydrogen for use in fuel cell vehicles, the tanks have other uses including for oxygen storage tanks in aerospace and emergency vehicle applications, storage of volatile and/or corrosive to ferrous or none ferrous metal gasses, and storage of nitrogen for aerospace or space purposes (e.g. nitrogen thrusters). In each of these applications, the tanks provide weight reduction, improved durability, and increased safety over conventional tanks, along with the ability to form structural components of a frame.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

For example, tanks including some combination of features shown in the embodiments described herein in any appropriate arrangement are intended to be within the scope of the disclosure. For example, tanks may include one or more of a graphene nanomaterial filler dispersed in the polymer adhesive matrix, one or more fixing parts integrated into the filament winding and overmoulded by or embedded in the polymer adhesive, a structural mesh sleeve surrounding the tank, and/or a structural rod extending in the tank along its longitudinal axis.

1. A tank for storing volatile gas under pressure, the tank comprising:
a wall formed of a filament wound carbon fibre reinforced polymer, wherein the tank is formed to provide an active load bearing structural element as a stressed member in a frame of a structure such that, in the structure in use, it bears static and dynamic forces from internal and external loads.

2. The tank as claimed in claim 1, wherein the wall is formed of a filament wound carbon fibre reinforced polymer having a graphene nanomaterial filler dispersed in a polymer adhesive matrix.

3. The tank as claimed in claim 2, wherein the tank is formed by design to have mechanical properties required of the structural element in the frame such that the structure complies to its required specification to fulfil its mechanical function.

4. The tank as claimed in claim 3, wherein one or more of: the filament winding pattern of the carbon fibre, a wall thickness, a wall shape, or one or more material properties of the polymer adhesive matrix, optionally including dispersed graphene nanomaterial filler; is configured such that the tank has mechanical properties required by the design of the structure.

5. The tank as claimed in claim 4, wherein the graphene nanomaterial filler dispersed in the polymer adhesive matrix comprises graphene nanoplatelets.

6. The tank as claimed in claim 1, wherein a polymer adhesive is an epoxy or a thermoset polymer.

7. The tank as claimed in claim 1, wherein the tank is linerless.

8. The tank as claimed in claim 1, wherein the tank is formed to store the gas under pressure in a range from 300 bar to 1000 bar.

9. The tank as claimed in claim 1, wherein the tank is formed to store compressed hydrogen, nitrogen, or oxygen in a liquid or gas phase.

10. The tank as claimed in claim 1, wherein the tank is formed such that a weight of the tank when full at operating pressure is at least 110% of the weight of the tank when empty.

11. The tank as claimed in claim 1, wherein the tank is formed to provide one or more integrated hardpoints for mechanical connection to other structural elements of the frame or for supporting other non-load bearing components of the structure.

12. The tank as claimed in claim 11, wherein the hardpoints comprise fixing parts integrated into the filament winding and overmoulded by or embedded in a polymer adhesive.

13. The tank as claimed in claim 12, wherein the fixing parts comprise one or more plates embedded in filament wound layers of the wall, and one or more anchors extending through the plate or plates and out of the wall to provide fixings for mechanical connection to other structural elements of the frame or for supporting other non-load bearing components of the structure.

14. The tank as claimed in claim 1, further comprising a structural mesh sleeve surrounding the tank, the structural mesh sleeve extending from the wall and being for coupling the tank to the structure in use such that the tank provides an active load bearing structural element in the frame of the structure.

15. The tank as claimed in claim 14, wherein the structural mesh sleeve is embedded in the wall in at least a polymer adhesive matrix of the wall, and optionally integrated in the filament winding of the wall.

16. The tank as claimed in claim 14, the structural mesh sleeve having one or more fixing means for mechanical connection to other structural elements of the frame or for supporting other non-load bearing components of the structure.

17. The tank as claimed in claim 1, further comprising a structural rod extending in the tank along its longitudinal axis and through the wall at opposite ends of the tank, the structural rod being for coupling the tank to the structure in use such that the tank provides an active load bearing structural element in the frame of the structure.

18. The tank as claimed in claim 17, wherein the filament winding of the wall is formed around the structural rod, such that the structural rod is embedded in the wall.

19. The tank as claimed in claim 17, wherein collars are arranged on the rod each having a flange extending radially from the rod, the filament winding of the wall being wound around a collar at opposite ends of the rod.

20. The tank as claimed in claim 17, wherein the rod has a hollow cross section defining a cavity, the rod being configured for fluid communication of pressurised gas to and from the tank, the tank further comprising a pressure regulator provided in sealed fluid communication with the cavity of the rod in order to convert the pressurised gas between the tank pressure and an external system pressure.

21-26. (canceled)
